(19) United States
(12) Patent Application Publication
(10) Pub. No.: US 2015/0302088 A1
(43) Pub. Date: Oct. 22, 2015

(54) Method and System for Providing Personalized Content

(71) Applicant: Yahoo! INC., Sunnyvale, CA (US)

(72) Inventor: Tingyi Wu, Beijing (CN)

(21) Appl. No.: 14/344,100

(22) PCT Filed: Mar. 15, 2013
(86) PCT No.: PCT/CN13/00302

§ 371 Date: Mar. 11, 2014

(51) Int. Cl. G06F 17/30; G06N 5/04

(52) U.S. Cl. CPC G06F 17/30861; G06N 5/04; G06F 17/30958

(57) ABSTRACT

Method and system for providing content are provided. A request for content is received from a user. An integrated graph is accessed for inferring topics of interest in connection with the request of the user. The integrated graph has been created for linking different types of information. One or more topics of interest of the user are estimated by traversing the integrated graph based on the request. Content is obtained in accordance with the estimated one or more topics of interest of the user. The content is transmitted to the user as a response to the request.

### BACKGROUND

1. Technical Field

The disclosure relates generally to a method and system for providing content.

2. Discussion of Technical Background

The advancement in the Internet has made it possible to make a tremendous amount of information accessible to users located anywhere in the world. With the explosion of information, new issues have arisen. Effort has been made to organize the vast amount of information for responding to a request for information in a more effective and systematic manner.

Since different users can be interested in different information, effort has been made towards identifying a user's interest. Conventional approaches focus only on users' explicit actions or requests, e.g., clicks on web pages, tags with like/dislike in association with web pages, or a search query including a certain topic. Hence, existing solutions for identifying users' interest do not address the issue of providing content based on users' implicit interest, without users' advices or specific topics indicated by requests. Therefore, there is a need to develop techniques to provide personalized content to a user to overcome the above drawbacks.

### SUMMARY

The present teaching describes methods, system, and programming for providing content.

In one exemplary embodiment, a method, implemented on at least one machine having at least one processor, storage, and a communication platform connected to a network for providing content, is provided. A request for content is received from a user. An integrated graph is accessed for inferring topics of interest in connection with the request of the user. The integrated graph has been created for linking different types of information. One or more topics of interest of the user are estimated by traversing the integrated graph based on the request. Content is obtained in accordance with the estimated one or more topics of interest of the user. The content is transmitted to the user as a response to the request.

In another exemplary embodiment, a method, implemented on at least one machine having at least one processor, storage, and a communication platform connected to a network for providing content, is provided. A request for content is automatically generated based on an action of a user. The action is with respect to content provided to the user as a response to a previous request. An integrated graph is accessed for inferring topics of interest in connection with the automatically generated request. The integrated graph has been created for linking different types of information. One or more topics of interest of the user are estimated by traversing the integrated graph based on the automatically generated request. Content is obtained in accordance with the estimated one or more topics of interest of the user. The content is transmitted to the user as a response to the automatically generated request.

In still another exemplary embodiment, a method, implemented on at least one machine having at least one processor, storage, and a communication platform connected to a network for creating an integrated graph, is provided. A plurality of types of information are obtained including information associated with a plurality of users. One or more sub-graphs are constructed based on respective types of information obtained. The one or more sub-graphs are integrated to create the integrated graph.

In yet another exemplary embodiment, a system including at least one machine having at least one processor, storage, and a communication platform connected to a network for providing content, is provided. The system includes a request analysis unit, an integrated graph unit, and a content obtaining unit. The request analysis unit is configured for receiving a request for content from a user. The integrated graph unit is configured for accessing an integrated graph created for linking different types of information that can be used for inferring topics of interest in connection with the request of the user. The integrated graph unit is further configured for estimating one or more topics of interest of the user by traversing the integrated graph based on the request. The content obtaining unit is configured for obtaining content in accordance with the estimated one or more topics of interest of the user. The content obtaining unit is further configured for transmitting the content to the user as a response to the request.

In a different exemplary embodiment, a system including at least one machine having at least one processor, storage, and a communication platform connected to a network for providing content, is provided. The system includes a request analysis unit, an integrated graph unit, and a content obtaining unit. The request analysis unit is configured for automatically generating a request based on action of a user. The action is with respect to content provided to the user as a response to a previous request. The integrated graph unit is configured for accessing an integrated graph created for linking different types of information that can be used for inferring topics of interest in connection with the automatically generated request. The integrated graph unit is further configured for estimating one or more topics of interest of the user by traversing the integrated graph based on the automatically generated request. The content obtaining unit is configured for obtaining content in accordance with the estimated one or more topics of interest of the user. The content obtaining unit is further configured for transmitting the content to the user as a response to the automatically generated request.

Other concepts relate to software for providing content. A software product, in accord with this concept, includes at least one machine-readable non-transitory medium and information carried by the medium.

In one exemplary embodiment, a machine-readable tangible and non-transitory medium having information for providing content, wherein the information, when read by the machine, causes the machine to receive a request for content from a user, access an integrated graph created for linking different types of information that can be used for inferring topics of interest in connection with the request of the user, estimate one or more topics of interest of the user by traversing the integrated graph based on the request, obtain content in accordance with the estimated one or more topics of interest of the user, and transmit the content to the user as a response to the request.

In a different exemplary embodiment, a machine-readable tangible and non-transitory medium having information for providing content, wherein the information, when read by the machine, causes the machine to automatically generate a request based on action of a user, wherein the action is with respect to content provided to the user as a response to a previous request, access an integrated graph created for linking different types of information that can be used for inferring topics of interest in connection with the automatically generated request, estimate one or more topics of interest of the user by traversing the integrated graph based on the automatically generated request, obtain content in accordance with the estimated one or more topics of interest of the user, and transmit the content to the user as a response to the automatically generated request.

### BRIEF DESCRIPTION OF THE DRAWINGS

The embodiments will be more readily understood in view of the following description when accompanied by the below figures and wherein like reference numerals represent like elements, wherein:

FIG. 1 is a high level depiction of an exemplary system for providing content, in accordance with a first application embodiment of the present teaching;

FIG. 2 is a high level depiction of another exemplary system for providing content, in accordance with a second application embodiment of the present teaching;

FIG. 3a illustrates an exemplary general structure of an integrated graph, in accordance with one embodiment of the present teaching;

FIG. 3b illustrates an exemplary embodiment of an integrated graph, in accordance with one embodiment of the present teaching;

FIG. 4 is a block diagram illustrating an exemplary embodiment of an integrated graph unit, in accordance with one embodiment of the present teaching;

FIG. 5 is a flow chart illustrating an exemplary process performed by an integrated graph unit, in accordance with one embodiment of the present teaching;

FIG. 6 is a block diagram illustrating an exemplary embodiment of a content personalization engine for providing content, in accordance with one embodiment of the present teaching;

FIG. 7 is a flow chart illustrating an exemplary method for providing content, in accordance with one embodiment of the present teaching;

FIG. 8 is a block diagram illustrating an exemplary embodiment of a topic selection unit, in accordance with one embodiment of the present teaching;

FIG. 9 is a flow chart illustrating an exemplary process performed by a topic selection unit, in accordance with one embodiment of the present teaching;

FIG. 10 is a block diagram illustrating an exemplary embodiment of a content obtaining unit, in accordance with one embodiment of the present teaching;

FIG. 11 is a flow chart illustrating an exemplary process performed by a content obtaining unit, in accordance with one embodiment of the present teaching;

FIG. 12 depicts a general computer architecture on which the present teaching can be implemented; and

FIG. 13 depicts a general mobile device architecture on which the present teaching can be implemented.

### DETAILED DESCRIPTION

Reference will now be made in detail to the embodiments of the present teaching, examples of which are illustrated in the accompanying drawings. While the present teaching will be described in conjunction with the embodiments, it will be understood that they are not intended to limit the present teaching to these embodiments. On the contrary, the present teaching is intended to cover alternatives, modifications, and equivalents, which may be included within the spirit and scope of the present teaching as defined by the appended claims.

In addition, in the following detailed description of embodiments of the present teaching, numerous specific details are set forth in order to provide a thorough understanding of the present teaching. However, it will be recognized by one of ordinary skill in the art that the present teaching may be practiced without these specific details. In other instances, well-known methods, procedures, components, and circuits have not been described in detail as not to unnecessarily obscure aspects of the embodiments of the present teaching.

Various embodiments in accordance with the present teaching provide a method and a system for providing content to a user. More specifically, the method and system in various embodiments of the present teaching relate to providing content based on an integrated graph in response to a request of a user. The integrated graph may link different types of information that can be used for inferring topics of interest in connection with the request of the user. The request may be in the form of a log-in action without indicating any specific topics of interest. The terms “topics of interest” and “topics of interests” are interchangeable in this application, when the number of interests is not determined with respect to the topics as in “topics of interest” and “topics of interests”.

The integrated graph may include different types of information linked to each other. For example, the information may be associated with: profiles of a plurality of users including the user sending the request, social relationships among the users, relationships between the users and web pages browsed by the users, relationships between the users and stored topics of interest of the users, relationships among different entities in accordance with knowledge, etc. Each entity (e.g., the users, the web pages, the stored topics, etc) in association with the information may be projected to a point in the integrated graph. Each relationship between two entities in association with the information may be represented by a line connection in the integrated graph between two corresponding points projected from the two entities.

The integrated graph may be utilized for inferring topics of interest in connection with a user's request. For example, a request is received from user A, who has been projected to point A in the integrated graph. A group of points can be found by tracing along the line connections from point A in the integrated graph, base on some stop criteria. Topics of interest associated with user A may be estimated based on entities corresponding to the group of points. The estimated topics may further be ranked based on distances, measured by steps of connections in the integrated graph, between point A and the group of points.

Still referring to the above example, personalized content for user A can be obtained from content sources in accordance with the estimated or ranked topics of interest. The personalized content may then be transmitted to user A as a response to the request.

Thus, even if there is no specific topics of interest indicated by the request or advised by the user, personalized content can still be provided to the user based on the integrated graph. Various methods in accordance with embodiments of the present teaching can be implemented on a machine having at least one processor, storage, and a communication platform connected to a network. For example, the machine may be a computer like a desktop, a laptop, or a mobile device like a cell phone.

Additional novel features will be set forth in part in the description which follows, and in part will become apparent to those skilled in the art upon examination of the following and the accompanying drawings or may be learned by production or operation of the examples.

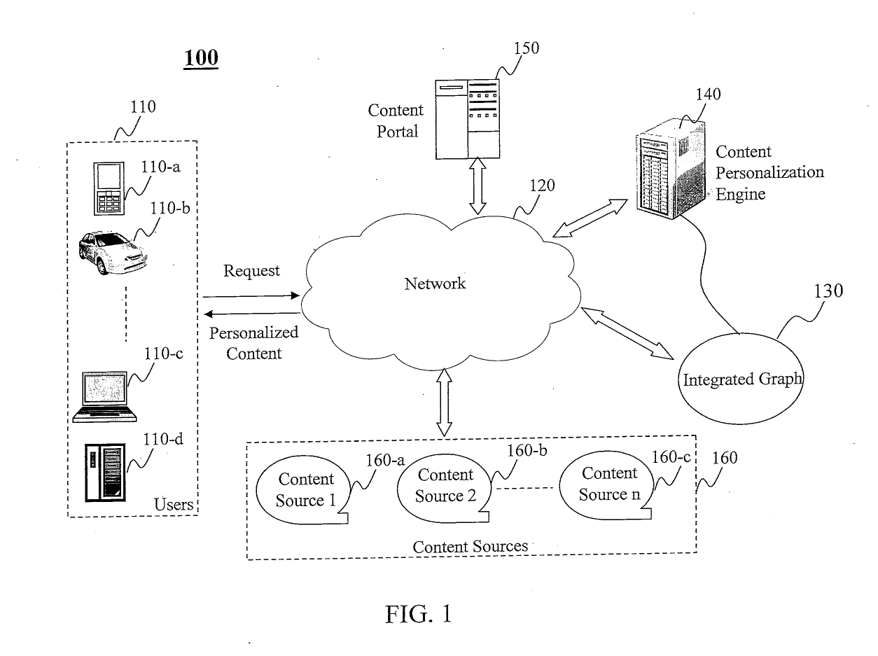

FIG. 1 is a high level depiction of an exemplary system 100 in which a content personalization engine 140 is deployed to provide content, according to a first application embodiment of the present teaching. The exemplary system 100 includes users 110, a network 120, a content portal 150, content sources 160, a content personalization engine 140, and an integrated graph 130. The network 120 in system 100 can be a single network or a combination of different networks. For example, a network can be a local area network (LAN), a wide area network (WAN), a public network, a private network, a proprietary network, a Public Telephone Switched Network (PSTN), the Internet, a wireless network, a virtual network, or any combination thereof.

Users 110 may be of different types such as users connected to the network via desktop connections (110-d), users connecting to the network via wireless connections such as through a laptop (110-c), a handheld device (110-a), or a built-in device in a motor vehicle (110-b). A user may send a request for content directly to both the content portal 150 and the content personalization engine 140 via the network 120 and receive personalized content through the network 120. The personalized content may be generated by the content personalization engine 140, in conjunction with the content portal 150, based on the content sources 160 and the integrated graph 130.

The integrated graph 130 may include multiple sub-graphs corresponding to different types of information associated with a plurality of users. The different types of information may be linked to each other in the integrated graph 130. Based on a request from a user, the content personalization engine 140 can infer topics of interest of the user by traversing the integrated graph 130. Personalized content may be generated from the content sources 160, based on the inferred topics of interest associated with the user.

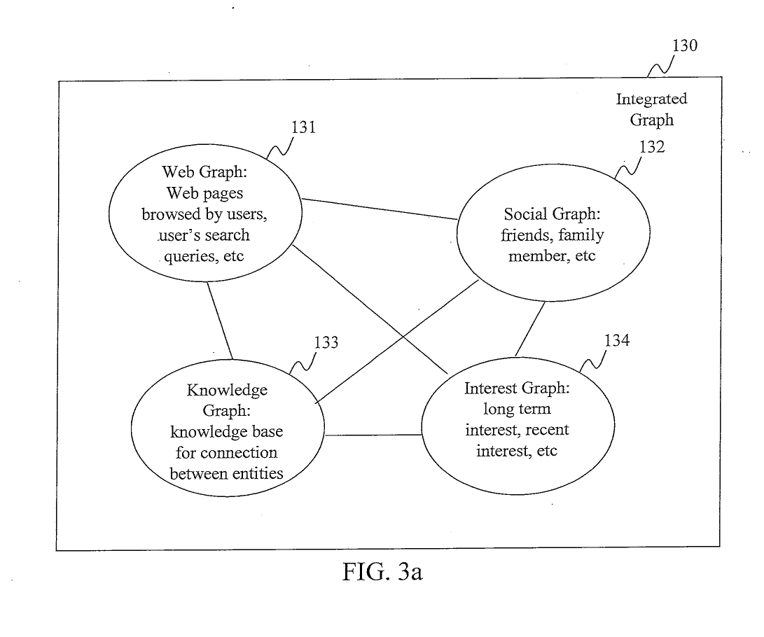

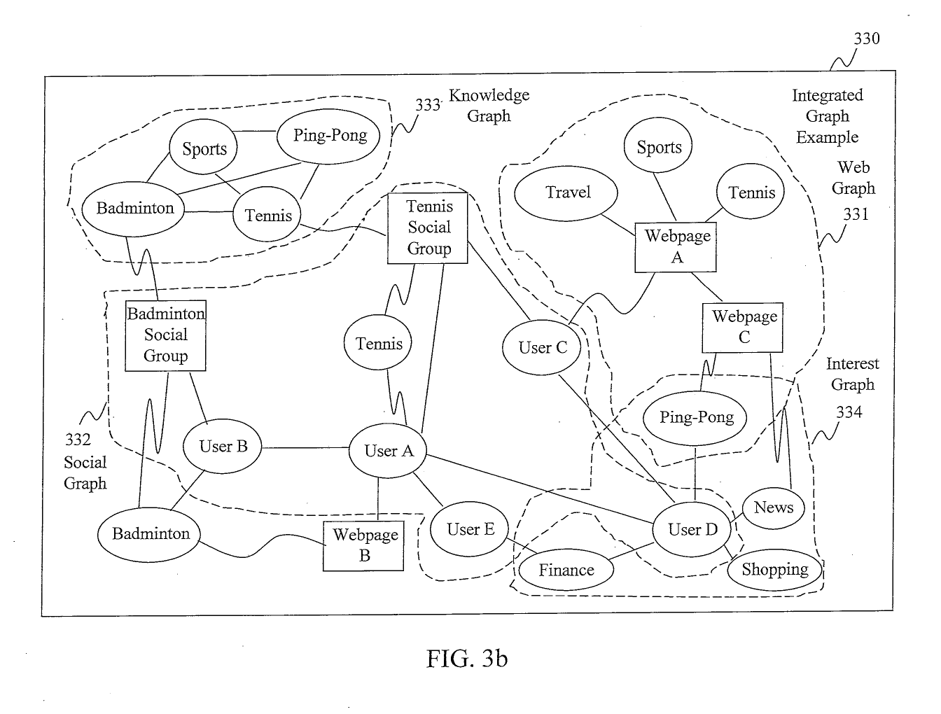

FIG. 3a illustrates an exemplary general structure of an integrated graph 130, in accordance with one embodiment of the present teaching. The integrated graph 130 may generated based on a plurality of sub-graphs. Each two sub-graphs may be connected. In this example, there may be different types of sub-graphs, for example, a web graph 131, a social graph 132, a knowledge graph 133, and an interest graph 134. It is understood that, in other example, the integrated graph 130 may include multiple sub-graphs belonging to the same type.

The web graph 131 may represent relationships between some users and some content associated with the users' online actions. For example, the content may include web pages browsed by the users, search queries input by the users, emails sent or received by the users, etc.

The social graph 132 may represent social connections among the users. For example, the social connections may include friends, family members, co-workers, or classmates. The social connections may also include online connections like followed by, following, or linked to. A social connection in the social graph 132 may be a derived connection between two users based on their connections with other users, when the other users are not included in the social graph 132. That is, if user A is a friend of user B, user B is followed by user C, and user B is not included in the social graph 132, then there may be a derived connection between users A and C in the social graph 132. In addition, a social group may be formed within the social graph 132 for representing a group of people having the same or similar topic of interest.

The knowledge graph 133 may represent relationships among different entities in accordance with knowledge. For example, entities like tennis, ping-pong, and badminton may all belong to an entity of sports, in accordance with people's knowledge. Thus, tennis, ping-pong, and badminton can all be connected to sports in the knowledge graph 133. In addition, tennis, ping-pong, and badminton may also be connected together in the knowledge graph 133 in accordance with users' knowledge.

The interest graph 134 may represent relationships between some users and topics of content that are previously stored or estimated be of interests to the users. The topics of content may be associated with the users' actions. The estimated interests of the users may be a long-term interest or a recent interest, based on time features of the users' associated actions.

In each of the sub-graphs, an entity (e.g., the users, the web pages, the stored topics, etc) in association with the users may be projected to a point in the sub-graph. Each relationship between two entities in association with the users may be represented by a connection, e.g. via a line, in the sub-graph between two corresponding points projected from the two entities.

The integrated graph 130 may be formed by integrating the sub-graphs. For example, points projected from the same entities in different sub-graphs can be combined or connected in the integrated graph 130. In addition, points projected from a group of entities with a common feature can be grouped together in the integrated graph 130.

FIG. 3b illustrates another exemplary embodiment of an integrated graph 330, in accordance with one embodiment of the present teaching. Multiple sub-graphs example of the integrated graph 330 are illustrated in this, e.g., a web graph 331, a social graph 332, a knowledge graph 333, and an interest graph 334. The web graph 331 may represent relationships between webpage A, webpage C, and other entities connected to the web pages A and C. The social graph 332 may represent relationships among users A-E, a badminton social group, and a tennis social group. The knowledge graph 333 may represent relationships among related entities like sports, badminton, ping-pong, and tennis. The interest graph 334 may represent relationships between user D and some topics of content that have been stored to be of interests to user D, e.g., finance, shopping, news, etc. The stored interests of user D may be generated based on a previous explicit action of user D, or based on a previous estimation of user D's interests using the integrated graph 330.

As shown in FIG. 3b, the sub-graphs in the example of integrated graph 330 can overlap or connect to each other. Although not shown in FIG. 3b, it is understood that in some embodiments, a connection between any two entities labeled the same in FIG. 3b. When the example of the integrated graph 330 is traversed with respect to a user, topics of interest of the user may be estimated based on entities connected, directly or indirectly, to the user in the example of integrated graph 330.

Referring back to FIG. 1, personalized content may be generated from the content sources 160, based on the estimated topics of interest associated with a user, by traversing the integrated graph 130. The content sources 160 in the exemplary system 100 include multiple content sources 160-a, 160-b, . . . , 160-c. A content source may correspond to a web page host corresponding to an entity, whether an individual, a business, or an organization such as USPTO.gov, a content provider such as cnn.com and Yahoo.com, or a content feed source such as tweeter or blogs. Both the content portal 150 and the content personalization engine 140 may access information from any of the content sources 160-a, 160-b, . . . , 160-c and rely on such information to respond to a request. For example, the content personalization engine 140 may retrieve content from the content sources 160 based on the estimated topics of interest of a user, to respond to a request from the user. The request may be in the form of a log-in action without indicating any specific topics of interest.

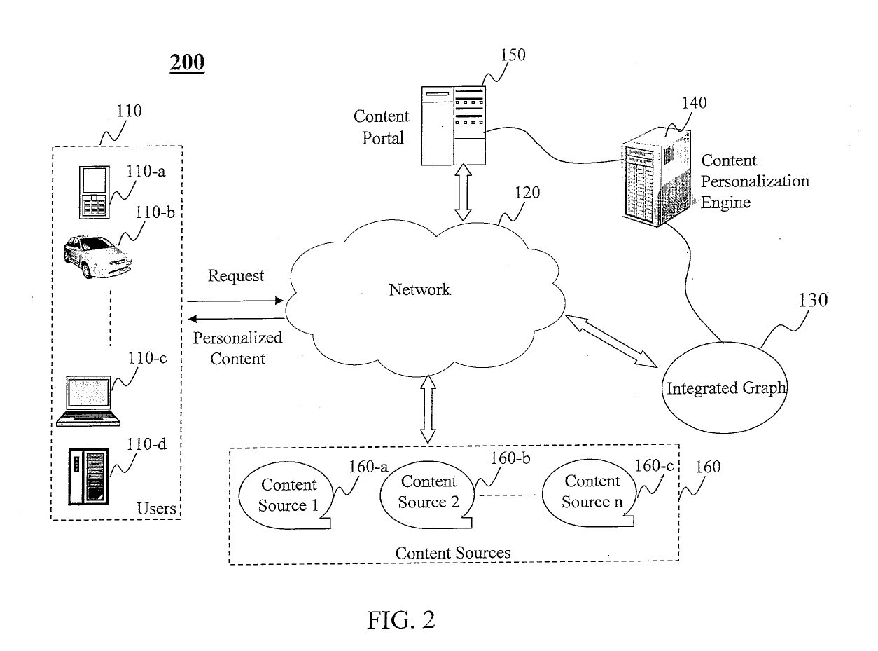

FIG. 2 is a high level depiction of an exemplary system 200 in which the content personalization engine 140 is deployed to provide content, according to a second application embodiment of the present teaching. In this embodiment, the content personalization engine 140 serves as a backend system of the content portal 150. All requests are sent to the content portal 150, which then invokes the content personalization engine 140 to process the content personalization.

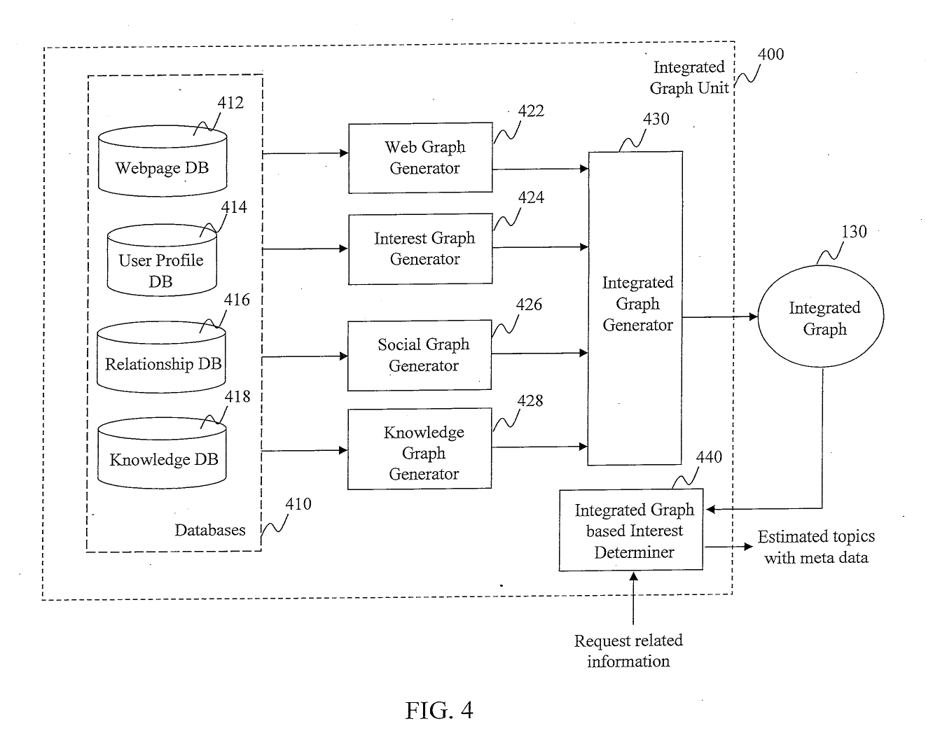

FIG. 4 is a block diagram illustrating an exemplary embodiment of an integrated graph unit 400 for generating, maintaining, and processing the integrated graph 130, in accordance with one embodiment of the present teaching. In some embodiments, the integrated graph unit 400 may be included in the content personalization engine 140. The integrated graph unit 400 in this example may include some databases 410, which may include a webpage database 412, a user profile database 414, a relationship database 416, and a knowledge database 418. The webpage database 412 may include content associated with the users' online actions. The user profile database 414 may include profiles of the users. The relationship database 416 may include social relationships among the users. The knowledge database 418 may include users' knowledge. In some embodiments, the databases 410 may be outside and connected to the integrated graph unit 400 via a network for example.

In this exemplary embodiment, the integrated graph unit 400 also includes a web graph generator 422 for generating web graphs, an interest graph generator 424 for generating interest graphs, a social graph generator 426 for generating social graphs, and a knowledge graph generator 428 for generating knowledge graphs. Each of the above graphs can be generated based on some of the databases 410. For example, a web graph can be generated based on the webpage database 412 and the user profile database 414.

In addition, the integrated graph unit 400 in this example includes an integrated graph generator 430 and an integrated graph based interest determiner 440. The integrated graph generator 430 may generate an integrated graph 130 based on the generated graphs from the generators 422, 424, 426, 428. The integrated graph based interest determiner 440 may maintain the integrated graph 130 or estimate topics of interest of a user based on the integrated graph 130 and some request related information associated with the user.

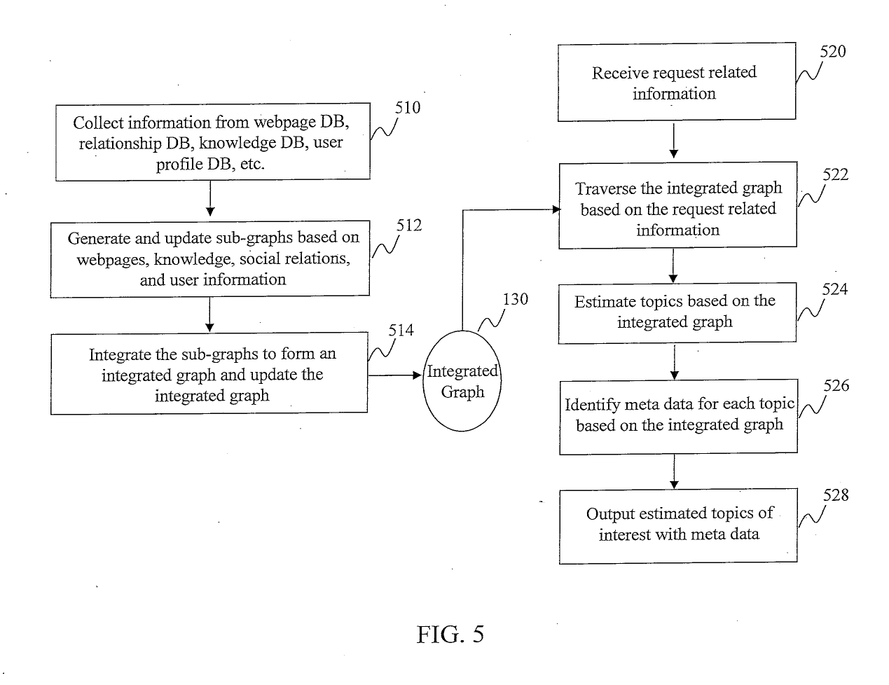

FIG. 5 is a flow chart illustrating an exemplary process performed by the integrated graph unit 400, in accordance with one embodiment of the present teaching. At 510, information may be collected from the databases 410. The collected information may include user information of the users, content associated with the users' online actions, social relationships among the users, interests of the users, users' knowledge, etc. At 512, sub-graphs can be generated based on the collected information. For example, each entity in association with the collected information may be projected to a point in a sub-graph. Each relationship between two entities in association with the collected information may be represented by a line connection in the sub-graph between two corresponding points projected from the two entities. The sub-graphs may include a web graph, an interest graph, a social graph, a knowledge graph, etc. The sub-graphs may be integrated, at 514, to form an integrated graph 130. For example, points projected from the same entities in different sub-graphs can be combined or connected in the integrated graph. In addition, points projected from a group of entities with a common feature can be grouped together in the integrated graph.

The process from 510 to 514 can be performed continuously. That is, information can be collected from time to time and updated continuously at 510; the sub-graphs generated at 512 can be updated continuously based on updated information; the integrated graph 130 generated at 514 can also be updated continuously based on the updated sub-graphs.

At 520 in FIG. 5, some request related information may be received at the integrated graph based interest determiner 440 in the integrated graph unit 400. The request related information can be associated with a user or a request from the user. For example, the request related information may include a user identification (ID) associated with the user. The request related information may also include information related to the request. In some embodiments, when the request is sent with a search query, the request related information can include topics of content associated with the search query.

At 522, the integrated graph 130 can be traversed based on the request related information. For example, if the request relation information is associated with user A, a point A may be projected from user A into the integrated graph 130. By traversing the integrated graph 130, a group of points can be found to be connected with point A in the integrated graph 130, base on some stop criteria. In one embodiment, the stop criteria may be based on a predetermined time period within which the traversing can be performed. For example, the traversing will stop after three seconds, even if some part of the integrated graph 130 has not been checked. In another embodiment, the stop criteria may be based on a predetermined maximum number of steps that a connection may have between point A and other candidate points in the integrated graph 130. For example, the traversing will stop after finding all points connected with point A within three steps.

At 524, one or more topics of content may be obtained upon traversing the integrated graph 130. Still referring to the above example regarding user A and point A, topics of content may be obtained based on entities corresponding to the group of points. For example, topics of content may be a portion of the entities corresponding to the group of points, if a specific type of topics can be determined based on the request related information.

An entity associated with the request related information can be referred as an origin entity with respect to the request. Correspondingly, point A in the above example can be referred as an origin point with respect to the request. There may be one or more origin entities and one or more corresponding origin points, based on the request related information. Thus, each obtained topic of content may be projected to a point in connection with, via one or more routes in the integrated graph 130, at least one of the origin points.

At 526, a set of meta data can be identified in association with each obtained topic of content. The meta data may include the one or more routes connecting the corresponding obtained topic and the corresponding origin entity. The integrated graph unit 400 can then output, at 528, the obtained topics with corresponding meta data. The output topics can be treated as estimated topics of interest for the user.

For example, suppose that the exemplary integrated graph 330 in FIG. 3b is traversed based on a request from user A and the request is associated with a search query “ping-pong”. Then topics of content can be obtained by tracing from either “user A” or “ping-pong” in the exemplary integrated graph 330. In this example, topics of “tennis,”, “ping-pong,” “badminton,” “sports,” “news,” “shopping,” and “finance,” can all be obtained. However, if the traversing stops with a maximum two-step connection, then the topic of “travel” should not be obtained in this example. The meta data associated with “news,” for example, may include two routes: one via “user D” and the other via “webpage C. All the obtained topics may then be output with corresponding meta data.

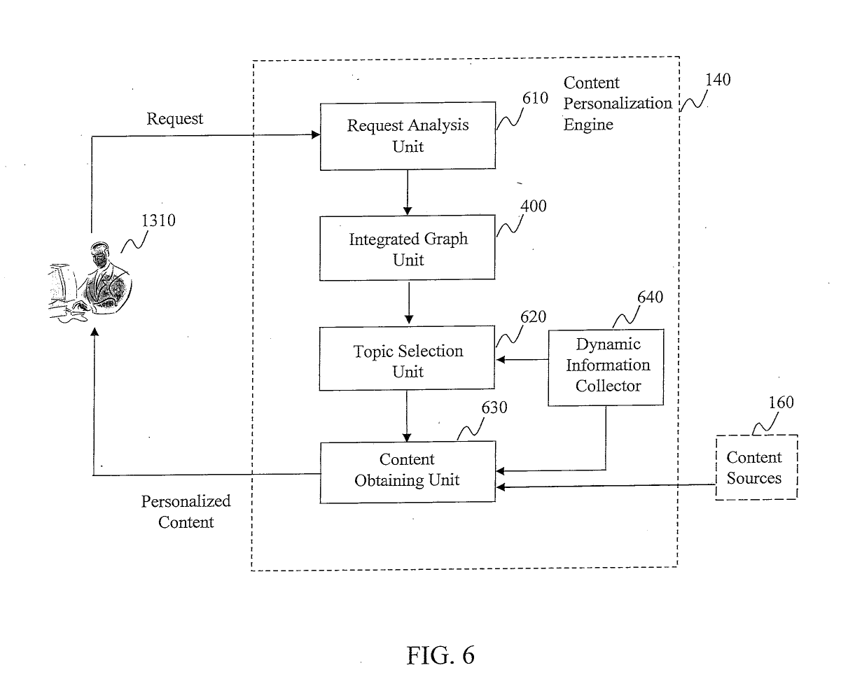

FIG. 6 is a block diagram illustrating an exemplary embodiment of a content personalization engine 140 for providing content, in accordance with one embodiment of the present teaching. In this exemplary embodiment, the content personalization engine 140 includes a request analysis unit 610, the integrated graph unit 400, a topic selection unit 620, a content obtaining unit 630, and an optional dynamic information collector 640. The request analysis unit 610 may receive a request for content from a user 1310 and analyze the request to generate request related information. The request related information, as described above, may include a user ID associated with the user 1310 or some topics of content associated with the request itself. The integrated graph unit 400, as described above, may be configured for generating estimated topics of interest based on an integrated graph. The topic selection unit 620 may select some topics from the estimated topics of interest based on some criteria. The content obtaining unit 630 may obtain content based on the selected topics and transmit the obtained content to the user 1310 as a response to the request. The obtained content can be personalized content for the user 1310 since they are obtained based on topics of interest associated with the user 1310.

In one embodiment, the criteria utilized by the topic selection unit 620 may include some dynamic information collected by the optional dynamic information collector 640. The dynamic information may include information associated with a user, e.g., the user's long term interests and recent interests. For example, a user may have a long term interest in finance due to the user's job and a recent interest in shopping due to a party in the near future. Topics associated with a recent interest may be selected with a higher priority than topics associated with a long term interest. The dynamic information may also include information associated with a device of the user, e.g., a display capacity of the device. For example, the smaller the display capacity is, the less topics may be selected.

In another embodiment, upon receiving the personalized content as a response to the request, the user may send a second request based on the personalized content or perform an action with respect to the personalized content. When the action of the user 1310 is performed, a third request may be automatically generated at the content personalization engine 140 based on the action. The second request and the third request may be processed by the content personalization engine 140 in a similar manner as processing the request.

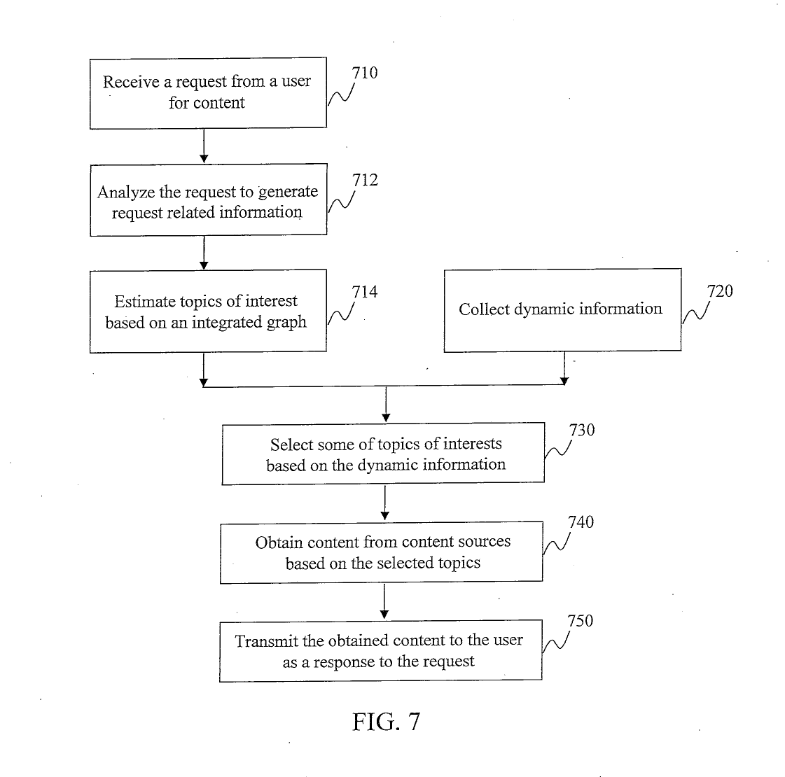

FIG. 7 is a flow chart illustrating an exemplary method for providing content, in accordance with one embodiment of the present teaching. At 710, a request for content may be received from the user. The request may then be analyzed at 712 to generate request related information. At 714, topics of interest can be estimated based on an integrated graph. For example, when the request related information includes a user ID or topics of interest can be estimated by tracing, in the integrated graph, for topics connected with an entity associated with the user ID, or say, an origin entity. Some or all of the estimated topics of interest may then be selected at 730 based on some criteria.

Optionally at 720, dynamic information associated with the user or a device thereof can be collected continuously. The criteria utilized at 730 may be based on the collected dynamic information at 720. At 740, content can be obtained from content sources based on the selected topics at 730. Then the obtained content may be transmitted to the user 1310 at 750, as a response to the request.

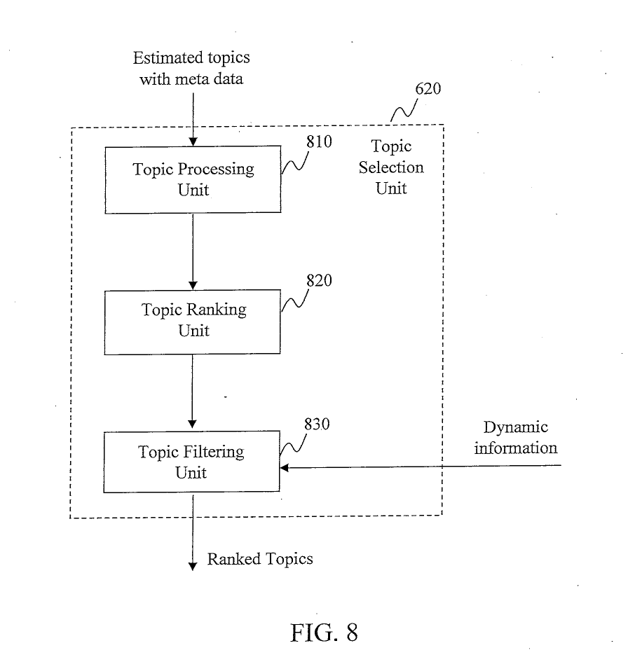

FIG. 8 is a block diagram illustrating an exemplary embodiment of a topic selection unit 620, in accordance with one embodiment of the present teaching. In this exemplary embodiment, the topic selection unit 620 includes a topic processing unit 810, a topic ranking unit 820, and an optional topic filtering unit 830. The topic processing unit 810 may obtain and process estimated topics of interest and corresponding meta data generated by the integrated graph unit 400. After the processing, some routes related information can be obtained with respect to each estimated topic. The route related information may include, for example, the number of steps in a connection, in the integrated graph, between an origin point and a point projected from the corresponding estimated topic. The topic ranking unit 820 may assign a weight to each estimated topic of content and rank the estimated topics of content based on the assigned weights. The weight may be assigned based on processed meta data associated with the topic. The process meta data may include the route related information as described above. The optional topic filtering unit 830 may select one or more of the ranked topics of interest based on some criteria. As described above, the criteria may be based on dynamic information associated with the user or a device thereof.

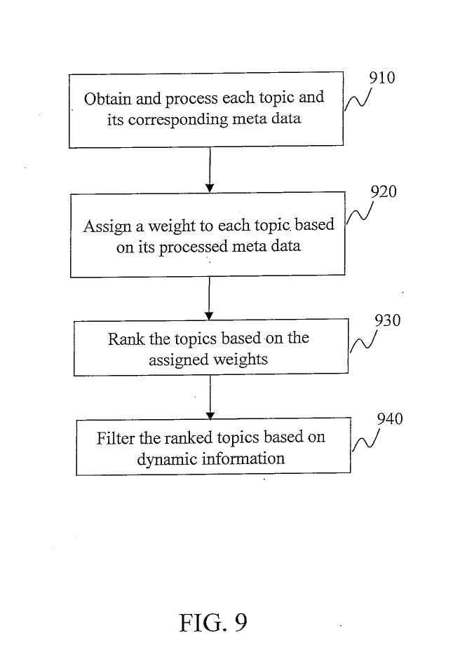

FIG. 9 is a flow chart illustrating an exemplary process performed by the topic selection unit 620, in accordance with one embodiment of the present teaching. At 910, each estimated topic and its corresponding meta data may be obtained and processed. Then each estimated topic can be assigned a weight, at 920, based on its corresponding processed meta data. The process meta data may include the route related information as described above. At 930, the estimated topics may be ranked based on the assigned weights. Optionally at 940, the ranked topics may be filtered based on some criteria, e.g., dynamic information associated with the user or a device thereof.

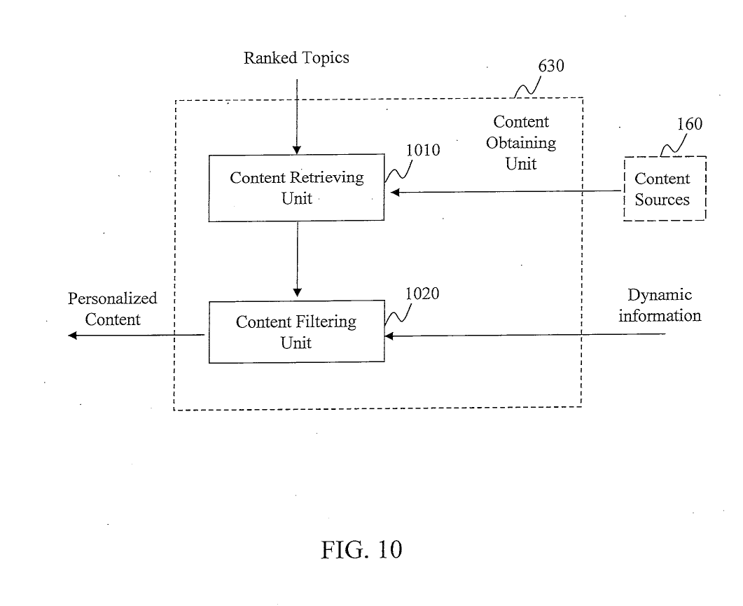

FIG. 10 is a block diagram illustrating an exemplary embodiment of a content obtaining unit 630, in accordance with one embodiment of the present teaching. In this exemplary embodiment, the content obtaining unit 630 includes a content retrieving unit 1010 and an optional content filtering unit 1020. The content retrieving unit 1010 may retrieve content from content sources based on the ranked topics generated by the topic selection unit 620. The retrieved content may be treated as personalized content for the user since they are obtained based on topics of interest associated with the user. The optional content filtering unit 1020 may filter the retrieved content based on some criteria and transmit the personalized content to the user. In case that there is no content filtering unit 1020 in the content obtaining unit 630, the content retrieving unit 1010 may transmit the personalized content to the user.

In one embodiment, the criteria may be based on dynamic information associated with the user and/or a device thereof, as described above. In another embodiment, the criteria may be based on information associated with the retrieved content. For example, the retrieved content may be filtered based on a recency feature and a similarity feature of the retrieved content. The recency feature may represent how recent the content is generated. The similarity feature of a group of content may represent a similarity among the group of content. On one hand, a group of retrieved content with a high similarity between each other can be combined or integrated if they have recency features that are close to each other. On the other hand, if a group of retrieved content with a high similarity between each other have different recency features, more recent content within the group of retrieved content can be selected.

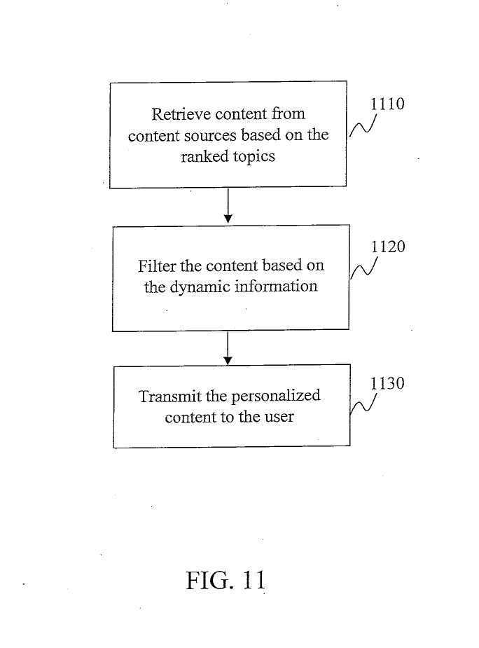

FIG. 11 is a flow chart illustrating an exemplary process performed by the content obtaining unit 630, in accordance with one embodiment of the present teaching. At 1110, personalized content may be retrieved from content sources based on the ranked topics generated by the topic selection unit 620. The personalized content can optionally be filtered, at 1120, based on some criteria. The criteria may be based on dynamic information associated with the user and/or a device thereof, or based on information associated with the retrieved content as described above for FIG. 10. Then at 1130, the personalized content can be transmitted to the user either by the content retrieving unit 1010 or by the optional content filtering unit 1020.

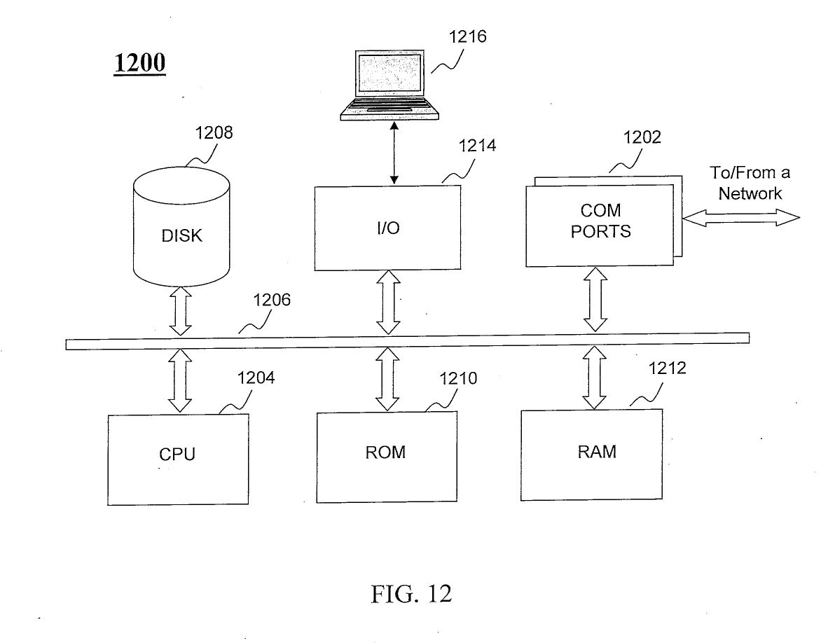

FIG. 12 depicts a general computer architecture on which the present teaching can be implemented and has a functional block diagram illustration of a computer hardware platform which includes user interface elements. The computer may be a general-purpose computer or a special purpose computer. This computer 1200 can be used to implement any components of the system for providing content as described herein. Different components of the systems 100, 200, e.g., as depicted in FIGS. 1 and 2, can all be implemented on one or more computers such as computer 1200, via its hardware, software program, firmware, or a combination thereof. Although only one such computer is shown, for convenience, the computer functions relating to dynamic relation and event detection may be implemented in a distributed fashion on a number of similar platforms, to distribute the processing load.

The computer 1200, for example, includes COM ports 1202 connected to and from a network connected thereto to facilitate data communications. The computer 1200 also includes a central processing unit (CPU) 1204, in the form of one or more processors, for executing program instructions. The exemplary computer platform includes an internal communication bus 1206, program storage and data storage of different forms, e.g., disk 1208, read only memory (ROM) 1210, or random access memory (RAM) 1212, for various data files to be processed and/or communicated by the computer, as well as possibly program instructions to be executed by the CPU. The computer 1200 also includes an I/O component 1214, supporting input/output flows between the computer and other components therein such as user interface elements 1216. The computer 1200 may also receive programming and data via network communications.

Hence, aspects of the method for providing content, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the computer-implemented method.

All or portions of the computer-implemented method may at times be communicated through a network such as the Internet or various other telecommunication networks. Such communications, for example, may enable loading of the software from one computer or processor into another. Thus, another type of media that may bear the elements of the computer-implemented method includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the computer-implemented method. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

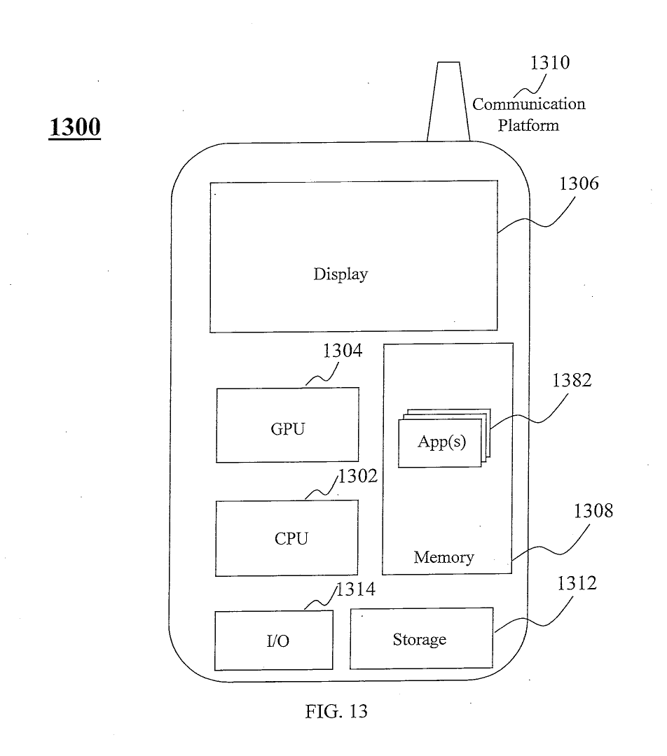

FIG. 13 depicts a general mobile device architecture on which the present teaching can be implemented and has a functional block diagram illustration of a mobile device hardware platform which includes user interface elements. The mobile device may be a general-purpose mobile device or a special purpose mobile device. In this example, the user device is a mobile device 1300, including but is not limited to, a smart phone, tablet, music player, handled gaming console, GPS. The mobile device 1300 in this example includes one or more central processing units (CPUs) 1302, one or more graphic processing units (GPUs) 1304, a display 1306, a memory 1308, a communication platform 1310, such as a wireless communication module, storage 1312, and one or more input/output (I/O) devices 1314. Any other suitable component, such as but not limited to a system bus or a controller (not shown), may also be included in the mobile device 1300. As shown in FIG. 13, one or more applications 1382 may be loaded into the memory 1308 from the storage 1312 in order to be executed by the CPU 1302. The applications 1382 may be executed on various mobile operating systems, e.g., iOS, Android, Windows Phone, etc. Execution of the applications 1382 may cause the mobile device 1300 to perform the processing as described above, e.g., in FIGS. 4, 5, 7, 9, and 11.

Those skilled in the art will recognize that the present teaching is amenable to a variety of modifications and/or enhancements. For example, although the implementation of various components described above may be embodied in a hardware device, it can also be implemented as a firmware, firmware/software combination, firmware/hardware combination, or a hardware/firmware/software combination.

While the foregoing description and drawings represent embodiments of the present teaching, it will be understood that various additions, modifications, and substitutions may be made therein without departing from the spirit and scope of the principles of the present teaching as defined in the accompanying claims. One skilled in the art will appreciate that the present teaching may be used with many modifications of form, structure, arrangement, proportions, materials, elements, and components and otherwise, used in the practice of the disclosure, which are particularly adapted to specific environments and operative requirements without departing from the principles of the present teaching. The presently disclosed embodiments are therefore to be considered in all respects as illustrative and not restrictive, the scope of the present teaching being indicated by the appended claims and their legal equivalents, and not limited to the foregoing description.

What is claimed is:

1. A method, implemented on a machine having at least one processor, storage, and a communication platform connected to a network for providing content, comprising:
receiving, via the communication platform, a request for content from a user;
accessing an integrated graph created for linking different types of information that can be used for inferring topics of interest in connection with the request of the user;
estimating one or more topics of interest of the user by traversing the integrated graph based on the request;
obtaining content in accordance with the estimated one or more topics of interest of the user; and
transmitting the content to the user as a response to the request.

2. The method of claim 1, wherein:
the integrated graph is created based on a plurality of sub-graphs associated with a plurality of users; and
the sub-graph includes at least one of a social graph, an interest graph, a web graph, and a knowledge graph.

3. The method of claim 2, wherein:
the social graph represents social connections among at least some of the plurality of users;
the interest graph represents at least a relationship between one or more of the plurality of users and topics of content that are estimated to be of interests to the one or more of the plurality of users;
the web graph represents at least a relationship between some of the plurality of users and one or more web pages browsed by the some of the users; and
the knowledge graph represents relationship among different entities in accordance with knowledge.

4. The method of claim 1, wherein the step of estimating the one or more topics of interest comprises:
obtaining one or more topics of content based on the integrated graph, wherein each topic of content is obtained in association with a corresponding set of meta data;
assigning a weight to each topic of content based on the corresponding set of meta data;
ranking the one or more topics of content based on the assigned weight;
collecting dynamic information associated with the user and/or a device thereof; and
selecting one or more topics of interest from the ranked one or more topics of content based on the dynamic information.

5. The method of claim 4, wherein the step of obtaining one or more topics of content comprises:
obtaining request related information based on the request; and
traversing the integrated graph to obtain the one or more topics of content based on the request related information, wherein
each one topic of content is, via one or more routes in the integrated graph, in connection with at least one entity associated with the request related information, and
a corresponding set of meta data in association with the one topic of content includes at least the one or more routes.

6. The method of claim 1, wherein the step of obtaining content comprises:
collecting dynamic information associated with the user and/or a device thereof;
retrieving content from one or more content sources based on the one or more estimated topics of interest; and
selecting content from the retrieved content based on the dynamic information.

7. A method, implemented on a machine having at least one processor, storage, and a communication platform connected to a network for providing content, comprising:
automatically generating a request based on an action of a user, wherein the action is with respect to content provided to the user as a response to a previous request;
accessing an integrated graph created for linking different types of information that can be used for inferring topics of interest in connection with the automatically generated request;
estimating one or more topics of interest of the user by traversing the integrated graph based on the automatically generated request;
obtaining content in accordance with the estimated one or more topics of interest of the user; and
transmitting the content to the user as a response to the automatically generated request.

8. A method, implemented on a machine having at least one processor, storage, and a communication platform connected to a network for creating an integrated graph, comprising:
obtaining a plurality of types of information including information associated with a plurality of users;
constructing one or more sub-graphs based on respective types of information obtained; and
integrating the one or more sub-graphs to create the integrated graph.

9. A system including at least one processor, storage, and a communication platform connected to a network for providing content, comprising:
a request analysis unit configured for receiving a request for content from a user;
an integrated graph unit configured for
accessing an integrated graph created for linking different types of information that can be used for inferring topics of interest in connection with the request of the user, and
estimating one or more topics of interest of the user by traversing the integrated graph based on the request; and
a content obtaining unit configured for
obtaining content in accordance with the estimated one or more topics of interest of the user, and
transmitting the content to the user as a response to the request.

10. The system of claim 9, wherein:
the integrated graph is created based on a plurality of sub-graphs associated with a plurality of users; and
the sub-graph includes at least one of a social graph, an interest graph, a web graph, and a knowledge graph.

11. The system of claim 10, wherein:
the social graph represents social connections among at least some of the plurality of users;
the interest graph represents at least a relationship between one or more of the plurality of users and topics of content that are estimated to be of interests to the one or more of the plurality of users;
the web graph represents at least a relationship between some of the plurality of users and one or more web pages browsed by the some of the users; and
the knowledge graph represents relationship among different entities in accordance with knowledge.

12. The system of claim 9, wherein
the integrated graph unit is further configured for obtaining one or more topics of content based on the integrated graph, where each topic of content is obtained in association with a corresponding set of meta data; and
the system further comprises
a topic processing unit configured for assigning a weight to each topic of content based on the corresponding set of meta data,
a topic ranking unit configured for ranking the one or more topics of content based on the assigned weight,
a dynamic information collector configured for collecting dynamic information associated with the user and/or a device thereof, and
a topic filtering unit configured for selecting one or more topics of interest from the ranked one or more topics of content based on the dynamic information.

13. The system of claim 12, wherein the integrated graph unit comprises an integrated graph based interest determiner configured for:
obtaining request related information based on the request; and
traversing the integrated graph to obtain the one or more topics of content based on the request related information, wherein
each one topic of content is, via one or more routes in the integrated graph, in connection with at least one entity associated with the request related information, and
a corresponding set of meta data in association with the one topic of content includes at least the one or more routes.

14. The system of claim 9, further comprising a dynamic information collector configured for collecting dynamic information associated with the user and/or a device thereof, wherein the content obtaining unit further comprises:
a content retrieving unit configured for retrieving content from one or more content sources based on the one or more estimated topics of interest; and
a content filtering unit configured for selecting content from the retrieved content based on the dynamic information.

15. A system including at least one processor, storage, and a communication platform connected to a network for providing content, comprising:
a request analysis unit configured for automatically generating a request based on an action of a user, wherein the action is with respect to content provided to the user as a response to a previous request;
an integrated graph unit configured for
accessing an integrated graph created for linking different types of information that can be used for inferring topics of interest in connection with the automatically generated request, and
estimating one or more topics of interest of the user by traversing the integrated graph based on the automatically generated request; and
a content obtaining unit configured for
obtaining content in accordance with the estimated one or more topics of interest of the user, and
transmitting the content to the user as a response to the automatically generated request.

16. A machine-readable tangible and non-transitory medium having information for providing content, wherein the information, when read by the machine, causes the machine to perform the following:
receiving, via the communication platform, a request for content from a user;
accessing an integrated graph created for linking different types of information that can be used for inferring topics of interest in connection with the request of the user;
estimating one or more topics of interest of the user by traversing the integrated graph based on the request;
obtaining content in accordance with the estimated one or more topics of interest of the user; and
transmitting the content to the user as a response to the request.

17. The medium of claim 16, wherein:
the integrated graph is created based on a plurality of sub-graphs associated with a plurality of users; and
the sub-graph includes at least one of a social graph, an interest graph, a web graph, and a knowledge graph.

18. The medium of claim 17, wherein:
the social graph represents social connections among at least some of the plurality of users;
the interest graph represents at least a relationship between one or more of the plurality of users and topics of content that are estimated to be of interests to the one or more of the plurality of users;
the web graph represents at least a relationship between some of the plurality of users and one or more web pages browsed by the some of the users; and
the knowledge graph represents relationship among different entities in accordance with knowledge.

19. The medium of claim 16, wherein the step of estimating the one or more topics of interest comprises:
obtaining one or more topics of content based on the integrated graph, wherein each topic of content is obtained in association with a corresponding set of meta data;
assigning a weight to each topic of content based on the corresponding set of meta data;
ranking the one or more topics of content based on the assigned weight;
collecting dynamic information associated with the user and/or a device thereof; and
selecting one or more topics of interest from the ranked one or more topics of content based on the dynamic information.

20. The medium of claim 19, wherein the step of obtaining one or more topics of content comprises:
obtaining a request related information based on the request; and
traversing the integrated graph to obtain the one or more topics of content based on the request related information, wherein
each one topic of content is, via one or more routes in the integrated graph, in connection with at least one entity associated with the request related information, and
a corresponding set of meta data in association with the one topic of content includes at least the one or more routes.

21. The medium of claim 16, wherein the step of obtaining content comprises:
collecting dynamic information associated with the user and/or a device thereof;
retrieving content from one or more content sources based on the one or more estimated topics of interest; and
selecting content from the retrieved content based on the dynamic information.

22. A machine-readable tangible and non-transitory medium having information for providing content, wherein the information, when read by the machine, causes the machine to perform the following:
automatically generating a request based on an action of a user, wherein the action is with respect to content provided to the user as a response to a previous request;
accessing an integrated graph created for linking different types of information that can be used for inferring topics of interest in connection with the automatically generated request;
estimating one or more topics of interest of the user by traversing the integrated graph based on the automatically generated request;
obtaining content in accordance with the estimated one or more topics of interest of the user; and
transmitting the content to the user as a response to the automatically generated request.
